(19) United States
(12) Patent Application Publication
(10) Pub. No.: US 2005/0188248 A1
(43) Pub. Date: Aug. 25, 2005

(54) Scalable storage architecture

(76) Inventors: John O'Brien, Short Hills, NJ (US); Nikita Shulga, Chernogolovka (RU)

Correspondence Address: RICHARD MILLMAN, 973 SPENCER ROAD, MCLEAN, VA, 22102, US

(21) Appl. No.: 10/841,745

(22) Filed: May 7, 2004

Related U.S. Application Data
(60) Provisional application No. 60/469,202, filed on May 9, 2003.

(51) Int. Cl. G06F 12/08; G06F 12/16

(52) U.S. Cl. 714/5; 711/159; 711/170; 711/203

(57) ABSTRACT

The Scalable Storage Architecture SSA system integrates everything necessary for network storage and provides highly scalable and redundant storage space. The SSA comprises integrated and instantaneous back-up for maintaining data integrity in such a way as to make external backup unnecessary. The SSA also provides archiving and Hierarchical Storage Management (HSM) capabilities for storage and retrieval of historic data.

### CROSS REFERENCE TO RELATED APPLICATIONS

This application claims priority under 35 U.S.C. § 119(e) from provisional application No. 60/469,202, filed May 9, 2003. The 60/469,202 provisional application is incorporate by reference herein, in its entirety, for all purposes.

### BACKGROUND

The present invention relates generally to the field of data storage. The Scalable Storage Architecture (SSA) is an integrated storage solution that is highly scalable and redundant in both hardware and software. The Scalable Storage Architecture system integrates everything necessary for network storage and provides highly scalable and redundant storage space with disaster recovery capabilities. Its features include integrated and instantaneous back up which maintains data integrity in such a way as to make external backup obsolete. It also provides archiving and Hierarchical Storage Management (HSM) capabilities for storage and retrieval of historical data.

More and more industries are relying upon increasing amounts of data. Nowhere is this more apparent then with the establishment of businesses on the Internet. As Internet usage rises, so to does the desire for information from those people who are users of the Internet. This places an increasing burden upon companies to make sure that they store and maintain data that will be desired by investors, users, employees, and others with appropriate needs. Data warehousing can be an extremely expensive venture for many companies requiring servers, controlled storage of data, and the ability to access and retrieve data when desired. In many cases this is too expensive a venture for an individual company to undertake on its own. Further data management poses a major problem. Many companies do not know how long they should keep data; how they should warehouse the data, and how they should generally manage their data retention needs.

The need for data storage is also increasing based upon new applications for such data. For example, entertainment requires the storage of large amounts of archived video, audio, and other types of data. The scientific market requires the storage of huge amounts of data. In the medical arena, data from a wide variety of sources is required to be stored in order to meet the needs of Internet users to retrieve and utilize such health related data.

Thus the need to accumulate data has resulted in a storage requirement crisis. Further, within individual companies there is a shortage of information technology and storage personnel to manage such a storage requirement task. Further the management of networks that would have such storage as a key component is increasingly complex and costly. Further existing storage technologies can be limited by their own architecture and hence would not be particularly accessible nor scalable should the need arise.

What is therefore required is a highly scalable, easily managed, widely distributed, completely redundant, and cost efficient method for storage and access of data. Such a capability would be remote from those individuals and organizations to which the data belongs. Further such data storage capability would meet the needs of the entertainment industry, the chemical and geologic sector, financial sectors, communications in medical records and imaging sectors as well as the Internet and government needs for storage.

### SUMMARY

It is therefore an objective of the present invention to provide for data storage in an integrated and easily accessible fashion remote from the owners of the data that is stored in the system.

It is a further objective of the present invention to provide data warehousing operations for individuals and companies.

It is still another objective of the present invention to provide growth and data storage for the entertainment, scientific, medical, and other data intensive industries.

It is a further objective of the present invention to eliminate the need for individual companies to staff information technology and storage personnel to handle the storage and retrieval of data.

It is still another objective of the present invention to provide accessible scalable storage architectures for the storage of information.

These and other objective of the present invention will become parent to those skilled in the art from a review of the specification that follows.

Every storage system design has a method of how and where to place data within the storage system. This method must deal with the scope or range of usable storage capacity as well the individual host connection mechanism used in accessing a specific storage element. Typically, engineering staff focuses on minimizing disk head movements for an individual spindle. In a RAID or multiple spindle system, the prior art data placement approach would typically be to stripe data across multiple drives so as to have as many drive heads engaged as possible, in simultaneously transferring data.

A distinction needs to be drawn between the act of allocation and the act of location, as they are highly related, yet different, in data storage transfers.

Allocation is the process of assigning resources. When requested by a host application, the file system responds by designating a suitable number of “allocation units”, or clusters, and it starts to store data at those physical locations. In this manner, the assignment of designated areas of a disk element to particular data (files) occurs. To help manage this process, there may be a block allocation map, or bit map, representing each available block of storage on a disk element and defining whether that block is in use or free. In this manner, the file system allocates space on the disk for files, cluster by cluster, and it blocks out unusable clusters, and maintains a list of unused or free areas, as well as maintaining a list of various file locations. Some systems support preallocation. This is the practice of allocating extra space for a file so that disk blocks will physically be part of a file before they are needed. Enabling an application to preallocate space for a file guarantees that a specified amount of space will be available for that file, even if the file system is otherwise out of space. Note, that the entire process of allocation and preallocation occurs in a constrained scope, or microscopic sense, and it does so with no explicit user involvement. Also, the choices made by the allocation algorithm can have a significant effect on the future efficiency of the host application, simply because of the immediate proximity of where data is allocated and stored within the file system and the time to effect transfers to those physical locations.

Location is the act of designating or selecting from among storage element resources. In effect, the act of selecting a location, is a macroscopic process as it involves user reasoning and input, and that reasoning is then integrated into a programmatic implementation which fixes the location of the data to be transferred. (Once the location is fixed, the dynamics of allocation are then superimposed on the selected location.) Thus, if one imagines an equation that integrates the contributions of allocation and location, in prior art systems, the value of location would be zero, while in a system of the present invention the value would be significant.

This selection may be done for efficiency reasons. For example, from a pool of six drives available, drive 3 has the least capacity used, therefore the algorithm selects drive three to more evenly distribute capacity and load.

The selection may be done for user-defined reasons. For example, from a pool of six drives available, the user has designated drives 1, 2, and 4 to have data striped across them. Consequently, data directed to that group of drives will be stripped across all three drives.

Thus where the action of allocation is an algorithmic response of the file system to a limited domain of storage capacity, the action of location is the fulfillment of a user's expressed intention with regard to selections and parameters that help decide where—and how—the user's data is to be located. Such parameters include, but ought not to be limited to, the following: (1) a selection of one or more drive elements from among a larger pool of drive elements where the selection criterion is the speed of the individual drive element, (2) a selection of one or more drive elements from among a larger pool of drive elements where the selection criterion is the monetary cost of the individual drive element, (3) a selection of one or more drive elements from among a larger pool of drive elements where the selection criterion is the capacity utilization of the individual drive element, (4) a selection of one or more drive elements from among a larger pool of drive elements where the selection of whether or not a drive element is a member of a set of drive elements linked by a common user assigned name, (5) a selection of one or more drive elements from among a larger pool of drive elements where the selection criterion is the vendor and drive model number of the individual drive element, (6) a selection of one or more drive elements from among a larger pool of drive elements where the selection criterion is the file type (example: .GIF .JPG .ixt, etc.) of the individual data transfer, (7) a selection of one or more drive elements from among a larger pool of drive elements where the selection criterion is the specific host or host bus adapter (HBA) of the individual drive element, (8) a selection of one or more drive elements from among a larger pool of drive elements where the selection criterion is the file size of the requested transfer, (9) a selection of one or more drive elements from among a larger pool of drive elements where the selection criterion is the day, date, or time of the requested transfer, (10) a selection of one or more drive elements from among a larger pool of drive elements where the selection criterion is the ability to stripe this transfer across multiple drive elements of the pool of drive elements, (11) a selection of one or more drive elements from among a larger pool of drive elements where the selection criterion is the closest (time and space) proximity to free space utilization of the individual drive element, (12) a selection of one or more drive elements from among a larger pool of drive elements where the selection criterion is the highest reliability of the individual drive elements, (13) a selection of one or more drive elements from among a larger pool of drive elements where the selection criterion is to store metadata separate from data for the individual drive element, and (14) a selection of one or more drive elements from among a larger pool of drive elements where the selection criteria is a combination of two or more of the immediately preceding mix of criteria.

Unlike the prior art which typically employs a single—one size fits all—method of fixing the location of data, the present invention provides a variety of different methods. The present invention embraces a variety of method options. For example, a user might elect to store metadata on one device while storing the associated actual data on other devices (this topic of the last sentence was taught in the DFI provisional application 60/169,372 filed 7 Dec. 1999). This would allow, for example, a database to store it's indexes on a solid state device to take advantage of the benefits of that type of storage media, and store, simultaneously or not simultaneously, associated data on the same or different storage media. For example, this would allow storing indexes on a fast solid state device, and the data copy on a less expensive slower magnetic device.

The present invention, therefore, provides a diverse range of optional methods for storing data, which are not limited as in the prior art. In addition, as some users or administrators may initially know more about their data than the system, the present invention allows the user or administrator to select a particular storage method from a list of alternatives. Those skilled in the art will recognize that selecting a storage method from a list of alternatives is only one technique of specifying storage parameters.

It is also possible, and within the scope of this invention, for the storage system to “learn” more about an individual user's storage habits and thereby adjust the storage method or methods regarding where to store any given data to achieve better operational efficiency. For example, the storage system may learn that certain files with certain extensions (.pdf for example) are created and then neither modified nor frequently accessed. Thus when it creates a pdf file for this user, the system might, in the absence of previous user defined expressions, store those pdf files on a slower and less expensive drive element. Those skilled in the art will recognize that there are many such examples of how a storage system might learn about a user's behavior and adapt itself to make storage operations more efficient and cost effective.

In view of the above, the present invention comprises a system and method for storage of large amounts of data in an accessible and scalable fashion. The present invention is a fully integrated system comprising primary storage media such as solid-state disc arrays and hard disc arrays, secondary storage media such as robotic tape or magneto-optical libraries, and a controller for accessing information from these various storage devices. The storage devices themselves are highly integrated and allow for storage and rapid access to information stored in the system. Further, the present invention provides secondary storage that is redundant so that in the event of a failure, data can be recovered and provided to users quickly and efficiently.

The present invention comprises a dedicated high-speed network that is connected to storage systems of the present invention. The files and data can be transferred between storage devices depending upon the need for the data, the age of the data, the number of times the data is accessed, and other criteria. Redundancy in the system eliminates any single point of failure so that an individual failure can occur without damaging the integrity of any of the data that is stored within the system.

### DESCRIPTION OF THE DRAWINGS

Additional objects and advantages of the present invention will be apparent in the following detailed description read in conjunction with the accompanying drawing figures.

FIG. 1 illustrates an integrated components view of a scalable storage architecture according to the present invention.

FIG. 2 illustrates a schematic view of the redundant hardware configuration of a scalable storage architecture according to the present invention.

FIG. 3 illustrates a schematic view of the expanded fiber channel configuration of a scalable storage architecture according to the present invention.

FIG. 4 illustrates a schematic view of the block aggregation device of a scalable storage architecture according to the present invention.

FIG. 5 illustrates a block diagram view of the storage control software implemented according to an embodiment of the present invention.

FIG. 6 illustrates a block diagram architecture including an IFS File System algorithm according to an embodiment of the present invention.

FIG. 7 illustrates a flow chart view of a fail-over algorithm according to an embodiment of the present invention.

### DETAILED DESCRIPTION

In the following description numerous specific details, such as nature of disks, disk block sizes, size of block pointers in bits, etc., are described in detail in order to provide a more thorough description of the present invention. It will be apparent, however, to one skilled in the art, that the present invention may be practiced without these specific details. In other instances, well-known features and methods have not been described in detail so as not to unnecessarily obscure the present invention.

The Scalable Storage Architecture (SSA) system integrates everything necessary for network attached storage and provides highly scalable and redundant storage space. The SSA comprises integrated and instantaneous back up for maintaining data integrity in such a way as to make external backup unnecessary. The SSA also provides archiving and Hierarchical Storage Management (HSM) capabilities for storage and retrieval of historic data.

One aspect of the present invention is a redundant and scalable storage system for robust storage of data. The system includes a primary storage medium consisting of data and metadata storage, and a secondary storage medium. The primary storage medium has redundant storage elements that provide instantaneous backup of data stored thereon. Data stored on the primary storage medium is duplicated onto the secondary storage medium. Sets of metadata are stored in the metadata storage medium.

Another aspect of the present invention is a method of robustly storing data using a system that has primary storage devices, secondary storage devices, and metadata storage devices. The method includes storing data redundantly on storage devices by duplicating it between primary and secondary devices. The method also includes capabilities of removing data from the primary device and relying solely on secondary devices for such data retrieval thus freeing up primary storage space for other data.

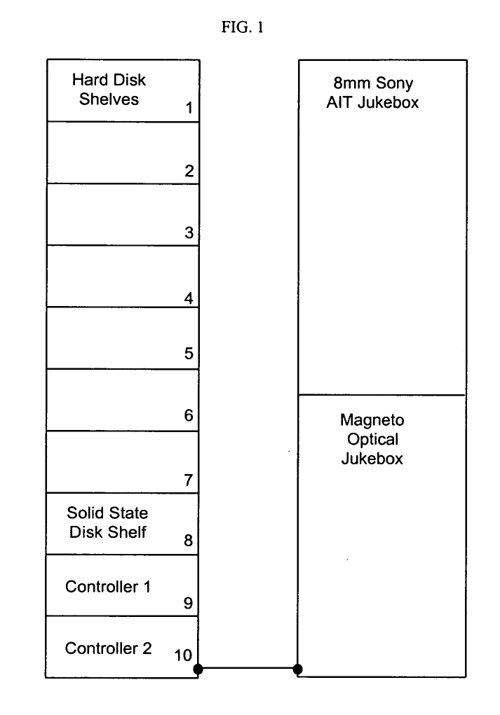

Referring to FIG. 1, the SSA hardware includes the redundant components in the SSA Integrated Components architecture as illustrated. Redundant controllers 10, 12 are identically configured computers preferably based on the Compaq® Alpha Central Processing Unit (CPU). They each run their own copy of the Linux kernel and the software according to the present invention implementing the SSA (discussed below). Additionally, each controller 10, 12 boots independently using its own Operating System (OS) image on its own hot-swappable hard drive(s). Each controller has its own dual hot-swappable power supplies. The controllers 10, 12 manage a series of hierarchical storage devices. For example, a solid-state disk shelf 28 comprises solid-state disks for the most rapid access to a client's metadata. The next level of access is represented by a series of hard disks 14, 16, 18, 20, 22, 24, 26. The hard disks provide rapid access to data although not as rapid as data stored on the solid-state disk 28. Data that is not required to be accessed as frequently but still requires reasonably rapid response is stored on optical disks in a magneto optical library 30. This library comprises a large number of optical disk on which are stored the data of clients and an automatic mechanism to access those disks. Finally, data that is not so time-constrained is stored on a tape, for example, an 8-millimeter Sony AIT automated tape library 32. This device stores large amounts of data on tape and, when required, tapes are appropriately mounted and data is restored and conveyed to clients.

Based upon data archiving policy, data that is most required and most required in a timely fashion are stored on the hard disks 14-26. As data ages further it is written to optical disks and stored in the optical disk library 30.

Finally, for data that is older (for example, according to corporate data retention policies), it is subsequently moved to an 8-millimeter tape and stored in the tape library 32. The data archiving policies may be set by the individual company in convey to the operator of the present invention or certain default values for data storage are applied where data storage and retrieval policies are not specified.

The independent OS images make it possible to upgrade the OS of the entire system without taking the SSA offline. As will be seen later, both controllers provide their own share of the workload during normal operations. However, each one can take over the functions of another one in case of failure. In the event of a failure, the second controller takes over the functionality of the full system and the system engineers safely replace disks and/or install a new copy of the OS. The dual controller configuration is then restored from the surviving operational controller. In the case of a full OS upgrade, the second controller can then be serviced in a similar way. Due to the redundancy in the SSA system of the present invention the same mechanism can be used to upgrade the hardware of the controllers without interrupting data services to users.

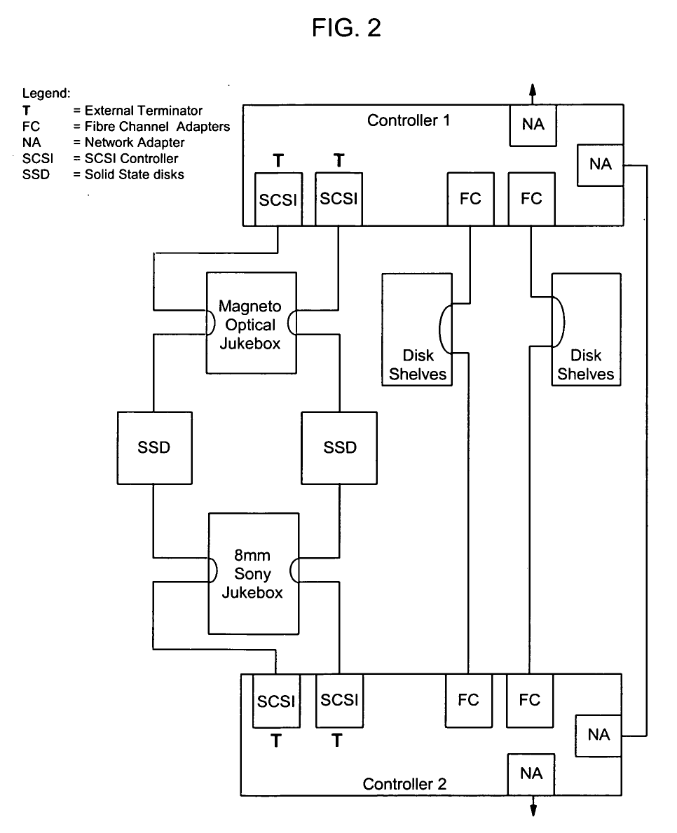

Referring to FIG. 2, a schematic view of the redundant hardware configuration of a scalable storage architecture according to the present invention is illustrated. Due to the inherent redundancy of the interconnect, any single component may fail without damaging the integrity of the data. Multiple component failures can also be tolerated in certain combinations.

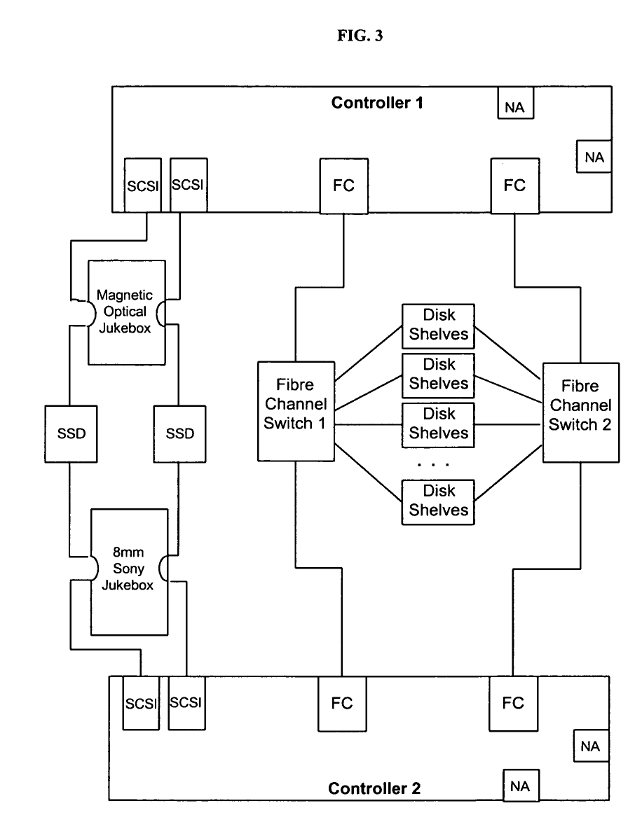

Referring to FIG. 3, each controller 10, 12 optionally has a number of hardware interfaces. These interfaces fall into three categories: storage attachment interfaces, network interfaces, and console or control/monitoring interfaces. Storage attachment interfaces include: Small Computer Systems Interface (SCSI)—30a, 30b, 32a, 32b (having different forms such as Low Voltage Differential (LVD) or High Voltage Differential (HVD)) and, Fibre Channel—34a, 36a, 34b, 36b. Network interfaces include but are not limited to: 10/100/1000 Mbit ethernet, Asynchronous Transfer Mode (ATM), Fiber Distributed Data Interface (FDDI), and Fiber Channel with Transmission Control Protocol/Internet Protocol (TCP/IP). Console or control/monitoring interfaces include serial, such as RS-232. The preferred embodiment uses Peripheral Component Interconnect (PCI) cards, particularly the hot-swappable PCI's.

All storage interfaces, except those used for the OS disks, are connected to their counterpart on the second controller. All storage devices are connected to the SCSI or FC cabling in between the controllers 10, 12 forming a string with controllers terminating strings on both ends. All SCSI or FC loops are terminated at the ends on the respective controllers by external terminators to avoid termination problems if one of the controllers should go down.

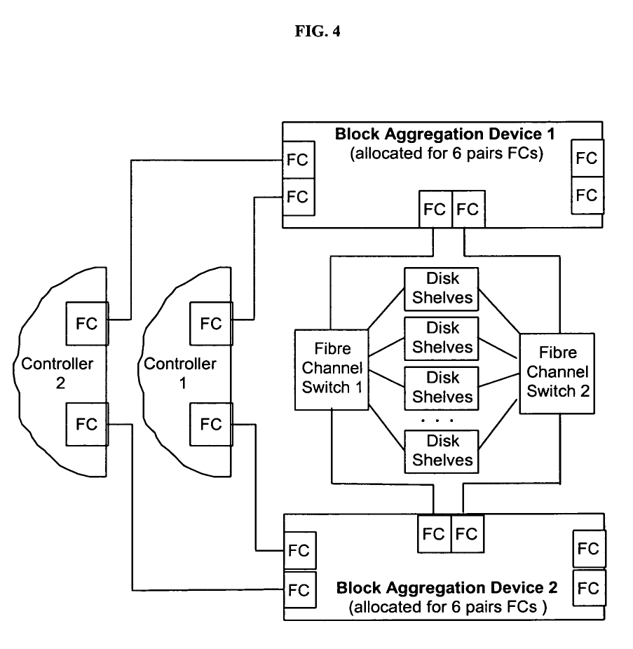

Referring further to FIG. 3, redundant controllers 10, 12 each control the storage of data on the present invention, as noted above, in order to insure that no single point failure exists. For example, the solid state disks 28, the magneto optical library 30, and the tape library 32 are each connected to the redundant controllers 10, 12 through SCSI interfaces 30a, 32a, 30b, 32b. Further, hard disks 14, 16, 18-26 are also connected to redundant controllers 10, 12 via a fiber channel switch 38, 40 to a fiber channel interface on each redundant controller 34a, 36a, 34b, 36b. As can thus be seen, each redundant controller 10, 12 is connected to all of the storage component of the present invention so that, in the event of a failure of any one controller, the other controller can take over all of the storage and retrieval operations.

Whereas the expansion of the fiber channels configuration is shown in FIG. 3, a modified expansion (the Block Aggregation Device) is shown in FIG. 4.

Referring to FIG. 4, an alternate architecture of the SSA that allows for further expansion is illustrated. Redundant controllers 10a, 10b each comprise a redundant fiber channel connector 70, 72, 74, 76 respectively. A fiber channel connector of each controller is connected to block aggregation devices 42, 44. Thus in the controllers 10a, 10b, fiber channel connectors 70, 74 are each connected to block aggregation device 42. In addition, fiber channel connector 72 of controller 10a and fiber channel connector 76 of controller 10b are in turn connected to block aggregation device 44.

The block aggregation devices allow for the expansion of hard disk storage units in a scalable fashion. Each block aggregation device comprises fiber channel connectors that allow connections to be made to redundant controllers 10a, 10b and to redundant arrays of hard disks. For example block aggregation devices 42, 44 are each connected to hard disks 14-26 via redundant fiber channel switches 38, 40 that in turn are connected to block aggregation devices 42, 44 via fiber channel connectors 62, 64 and 54, 56 respectively.

The block aggregation devices 42, 44 are in addition connected to redundant controllers 10a, 10b via fiber channels 58, 60 and 46, 48 respectively. In addition, the block aggregation devices 42, 44 each have expansion fiber channel connectors 66, 68 and 50, 52 respectively in order to connect to additional hard disk drives should the need arise.

The SSA product is preferably based on a Linux operating system. There are six preferred basic components to the SSA software architecture:
Modularized 64 bit version of Linux kernel for Alpha CPU architecture;
Minimal set of standard Linux user-level components;
SSA storage module;
User data access interfaces for management and configuration redundancy;
Management, configuration, reporting, and monitoring interfaces; and
Health Monitor reports and interface for redundancy.

The present invention uses the standard Linux kernel so as to avoid maintaining a separate development tree. Furthermore, most of the main components of the system can be in the form of kernel modules that can be loaded into the kernel as needed. This modular approach minimizes memory utilization and simplifies product development, from debugging to upgrading the system.

For the OS, the invention uses a stripped down version of the RedHat Linux distribution. This involves rebuilding Linux source files as needed to make the system work on the Alpha platform. Once this is done, the Alpha-native OS is repackaged into the RedHat Package Manager (RPM) binary format to simplify version and configuration management. The present invention includes useful network utilities, configuration and analysis tools, and the standard file/text manipulation programs.

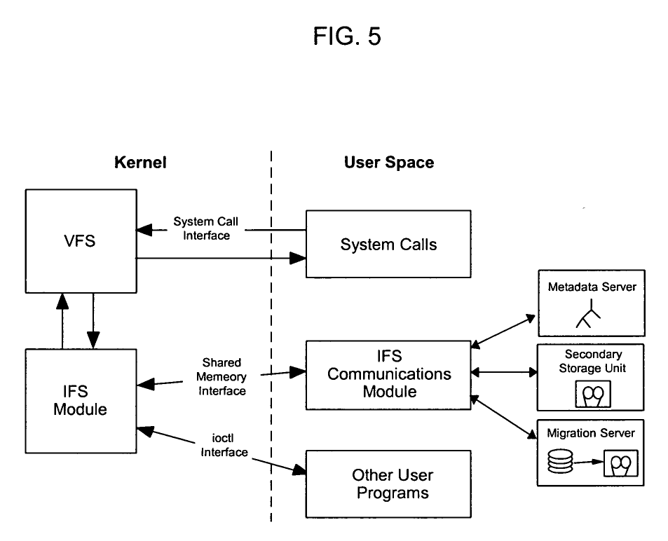

Referring to FIG. 5, the SSA storage module is illustrated. The SSA Storage Module is divided into the following five major parts:
IFS File System(s) 78, 79, which is the proprietary file system used by SSA;
Virtualization Daemon (VD) 80;
Database Server (DBS) 82;
Repack Server(s) (RS) 84; and
Secondary Storage Unit(s) (SSU) 86.

IFS is a new File System created to satisfy the requirements of the SSA system. The unique feature of IFS is its ability to manage files whose metadata and data may be stored on multiple separate physical devices having possibly different characteristics (such as seek speed, data bandwidth and such).

IFS is implemented both as a kernel-space module 78, and a user-space IFS Communication Module 79. The IFS kernel module 78 can be inserted and removed without rebooting the machine.

Any Linux file system consists of two components. One of these is the Virtual File System (VFS) 88, a non-removable part of the Linux kernel. It is hardware independent and communicates with the user space via a system call interface 90. In the SSA system, any of these calls that are related to files belonging to IFS 78, 79 are redirected by Linux's VFS 88 to the IFS kernel module 78. Additionally, there are several ubiquitous system calls that have been implemented in a novel manner, in comparison with existing file systems, in that they require communication with the user-space to achieve instantaneous backup and archiving/HSM capabilities. These calls are creat, open, close, unlink, read, and write.

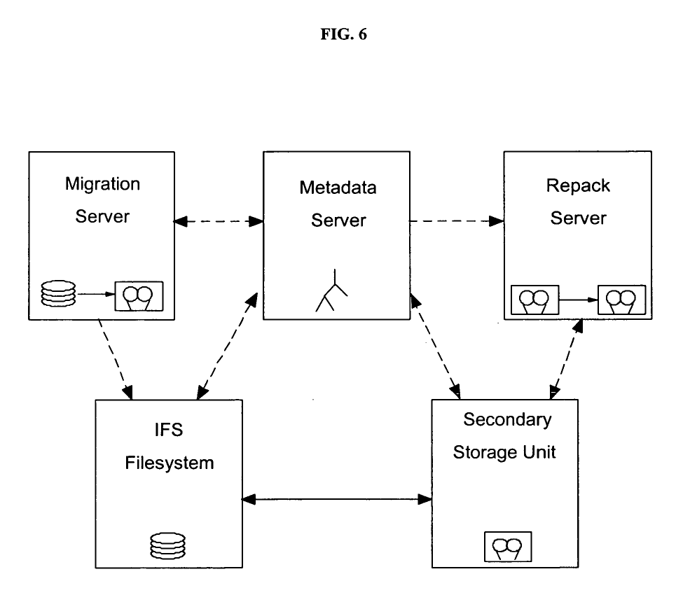

In order to handle certain system calls, the IFS kernel module 78 may communicate with the IFS Communication Module 79, which is placed in user-space. This is done through a Shared Memory Interface 92 to achieve speed and to avoid confusing kernel scheduler. The IFS Communications Module 79 also interfaces three other components of the SSA product. These are the Database Server 82, the Virtualization Daemon 80, and the Secondary Storage Unit 86, as shown in FIG. 6.

The Database Server (DBS) 82 stores information about the files which belong to IFS such as the identification number of the file (inode number+number of primary media where a file's metadata is stored), the number of copies of the file, timestamps corresponding to the times they were written, the numbers of the storage devices where data is stored, and related information. It also maintains information regarding free space on the media for intelligent file storage, file system back views (snapshot-like feature), device identification numbers, device characteristics, (i.e., speed of read/write, number and type of tapes, load, availability, etc.), and other configuration information.

The DBS 82 is used by every component of the SSA. It stores and retrieves information on request (passively). Any SQL-capable database server can be used. In the described embodiment a simple MySQL server is used to implement the present invention.

The Virtualization Daemon (VD) 80 is responsible for data removal from the IFS's primary media. It monitors the amount of hard disk space the IFS file system is using. If this size surpasses a certain threshold, it communicates with the DBS and receives back a list of files whose data have already been removed to secondary media. Then, in order to remove those files' data from the primary media, the VD communicates with IFS, which then deletes the main bodies of the files, thus freeing extra space, until a pre-configured goal for free space is reached. This process is called “virtualization”. Files that do not have their data body on the primary storage or have partial bodies are called “virtual”.

An intelligent algorithm is used to choose which files should be virtualized first. This algorithm can be configured or replaced by a different one. In the current embodiment the virtualization algorithm it chooses Least Recently Used (LRU) files and then additionally orders the list by size to virtualize largest files first to minimize number of virtual files on the IFS because un-virtualize operation can be time-consuming due to large access times of the secondary storage.

The Secondary Storage Unit (SSU) 86 is a software module that manages each Secondary Media Storage Device (SMSD) such as a robotically operated tape or optical disk library. Each SMSD has a SSU software component that provides a number of routines that are used by the SMSD device driver to allow effective read/write to the SMSD. Any number of SMSDs can be added to the system. When a SMSD is added, its SSU registers itself with the DBS in order to become a part of the SSA System. When a SMSD is removed, its SSU un-registers itself from the DBS.

When data needs to be written from the IFS to a SMSD, the IFS 78 with the aid of IFS Communication Module 79 communicates with the DBS 82 and obtains the address of the SSUs 86 on which it should store copies of the data on. The IFS Communication Module 79 then connects to the SSUs 86 (if not connected yet) and asks SSUs 86 to retrieve the data from the file system. The SSUs 86 then proceed to copy the data directly from the disks. This way there is no redundant data transfer (data does not go through DBS, thus having the shortest possible data path).

When large pieces of data are removed from a tape, it may result in large regions of unutilized media. This makes reading from those tapes very inefficient. In order to fix this shortcoming the data is rewritten (repacked) on a new tape via instructions from a repack server 84, freeing up the original tape in the process. The Repack Server (RS) 84 manages this task. The RS 84 is responsible for keeping data efficiently packaged on the SMSDs. With the help of the DBS 82 the RS 84, it monitors the contents of the tapes.

IFS is a File System which has most of the features of today's modern File Systems such as IRIX's XFS, Veritas, Ext2, BSD's FFS, and others. These features include a 64 bit address space, journaling, snapshot-like feature called back views, secure undelete, fast directory search and more. IFS also has features which are not implemented in other File Systems such as the ability to write metadata and data separately to different partitions/devices, and the ability not only to add but to safely remove a partition/hard drive. It can increase and decrease its size, maintain a history of IFS images, and more.

Today's Linux's OS uses the 32 bit Ext2 file system. This means that the size of the partition where the file system is placed is limited to 4 terabytes and the size of any particular file is limited to 2 gigabytes. These values are quite below the requirements of a File System that needs to handle files with sizes up to several terabytes. The IFS is implemented as a 64 bit File System. This allows the size of a single file system, not including the secondary storage, to range up to 134,217,700 petabytes with a maximum file size of 8192 petabytes.

The present invention uses UFS-like file-system layout. This disk format system is block based and can support several block sizes most commonly from 1 kB to 8 kB, uses inodes to describe its files, and includes several special files. One of the most commonly used type of special file is directory file which is simply a specially formatted file describing names associated with inodes. The file system also uses several other types of special files used to keep file-system metadata: superblock files, block usage bitmap files (bbmap) and inode location map (imap) files. The superblock files are used to describe information about a disk as a whole. The bbmap files contain information that indicates which blocks are allocated. The imap files indicate the location of inodes on the device.

The described file-system can optionally handle many independent disks. Those disks do not have to be of the same size, speed of access or speed of reading/writing. One disk is chosen at file-system creation time to be the master disk (master) which can also be referred to as metadata storage device. Other disks become slave disks which can be referred to as data storage devices. Master holds the master superblock, copies of slave superblocks and all bbmap files and imap files for all slave disks. In one embodiment of the present invention a solid-state disk is used as a master. Solid-state disks are characterized by a very high speed of read and write operations and have near 0 seek time which speeds up the metadata operations of the file-system. Solid-state disks are also characterized by a substantially higher reliability, then the common magneto-mechanical disks. In another embodiment of the present invention a small 0+1 RAID array is used as a master to reduce overall cost of the system while providing similarly high reliability and comparable speed of metadata operations.

The superblock contains disk-wide information such as block size, number of blocks on the device, free blocks count, inode number range allowed on this disk, number of other disks comprising this file-system, 16-byte serial number of this disk and other information.

Master disk holds additional information about slave devices called device table. Device table is located immediately after the superblock on the master disk. When the file-system is created on a set of disks or a disk is being added to already created file-system (this process will be described later), each slave disk is being assigned a unique serial number, which is written to the corresponding superblock. Device table is a simple fixed-sized list of records each consisting of the disk size in blocks, the number describing how to access this disk in the OS kernel, and the serial number.

When the file-system is mounted, only the master device name is passed to the mount system call. The file-system code reads the master superblock and discovers the size of the device table from it. Then file-system reads the device table and verifies that it can access each of the listed devices by reading its superblock and verifying that the serial number in the device table equals that in the superblock of the slave disk. If one or more serial numbers do not match, then the file-system code obtains a list of all available block devices from the kernel and tries to read serial numbers from each one of them. This process allows to quickly discover the proper list of all slave disks even if some of them changed their device numbers. It also establishes whether any devices are missing. Recovery of data when one or more of the slave disks are missing is discussed later.

The index of the disk in the device table is the internal identifier of said disk in the file-system.

All pointers to disk blocks in the file-system are stored on disk as 64-bit numbers where upper 16 bits represent disk identifier as described above. This way the file-system can handle up to 65536 independent disks each containing up to 248 blocks. The number of bits in the block address dedicated to disk identifier can be changed to suit the needs of a particular application.

For each slave disk added to the file-system at either creation time or when disk is added three files are created on the master disk: the copy of the slave superblock, the bbmap and the imap.

The bbmap of each disk is a simple bitmap where the index of the bit is the block number and the bit content represents allocation status: 1 means allocated block, 0 means free block.

The imap of each disk is a simple table of 64-bit numbers. The index of the table is the inode number minus the first allowed inode on this disk (taken from the superblock of this disk), and the value is the block number where inode is located or 0 if this inode number is not in use.

On-disk inodes of the file-system described in the present invention are similar to on-disk inodes described for prior art block-based inode file-systems: flags, ownerships, permissions and several dates are stored in the inode as well as the size of file in bytes and 15 64-bit block pointers (as described earlier) of which there are 12 direct, 1 indirect, 1 double indirect and 1 triple indirect. The major difference is three additional numbers. One 16-bit number is used for storing flags describing inode state in regards to the state of the backup copy/copies of this file on the secondary storage medium: whether a copy exists, whether the file on disk represents an entire file or a portion of it, and other related flags described later in the backup section. Second number is a short number containing inheritance flag. The third number is a 64-bit number representing the number of bytes of the file on disk counting from the first byte (on-disk size). In the present invention any file may exist in several forms: only on disk, on disk and on backup media, partially on disk and on backup media, and only on backup media. Any backup copy of the file is complete: the entire file is backed up. After the backup of the file happened said file may be truncated to arbitrary size including 0 bytes. Such incomplete file is called virtual and such truncation is called virtualization. The new on-disk size is stored in the number described above, while the file size number is not modified so that file-system reports correct size of the entire file irregardless of whether it is virtual or not. When virtual file is being accessed, the backup subsystem initiates the restore of the missing from disk portion of the file.

Journaling is a process that makes a File System robust with respect to OS crashes. If the OS crashes, the FS may be in an inconsistent state where the metadata of the FS doesn't reflect the data. In order remove these inconsistencies, a file system check (fsck) is needed. Running such a check takes a long time because it forces the system to go linearly through each inode, making a complete check of metadata and data integrity. A Journaling process keeps the file system consistent at all times avoiding the lengthy FS checking process.

In implementation, a Journal is a file with information regarding the File System's metadata. When file data has to be changed in a regular file system, the metadata are changed first and then data itself are updated. In a Journaling system, the updates of metadata are written first into the journal and then, after the actual data are updated, those journal entries are rewritten into the appropriate inode and superblock. It is not surprising that this process takes slightly longer (30%) than it would in an ordinary (non-journaling) file system. Nonetheless, it is felt that this time is a negligible payment for robustness under system crashes.

Some other existing File Systems use journaling, however the journal is usually written on the same hard drive as the File System itself which slows down all file system operations by requiring two extra seeks on each journal update. The IFS journaling system solves this problem. In IFS, the journal is written on a separate device such as a Solid State Disk whose read/write speed is comparable to the speed of memory and has virtually no seek time thus almost entirely eliminating overhead of the journal.

Another use of the Journal in IFS is to backup file system metadata to secondary storage. Journal records are batched and transferred to CM, which subsequently updates DBS tables with certain types of metadata and also sends metadata to SSU for storage on secondary devices. This mechanism provides for efficient metadata backup that can be used for disaster recovery and for creation of Back Views, which will be discussed separately.

Soft Updates are another technique that maintains system consistency and recoverability under kernel crashes. This technique uses a precise sequence for updating file data and metadata. Because Soft Updates comprise a very complicated mechanism which requires a lot of code (and consequently, system time), and it does not completely guarantee the File System consistency, IFS implements Soft Updates in its partial version as a compliment to journaling.

Snapshot is the existing technology used for getting a read-only image of a file system frozen in time. Snapshots are images of the file system taken at predefined time intervals. They are used to extract information about the system's metadata from a past time. A user (or the system) can use them to determine what the contents of directories and files were some time ago.

Back Views is a novel and unique feature of SSA. From a user's perspective it is a more convenient form of snapshots, however unlike snapshots the user should not “take a snapshot” at a certain time to be able to obtain a read-only image of the file system from that point of time in the future. Since all of the metadata necessary for recreation of the file system is being copied to the secondary storage and most of it is also duplicated in the DBS tables, it is trivial to reconstruct the file system metadata as it existed at any arbitrary point of time in the past with certain precision (about 5 minutes, depending on the activity of updates to the file system at that time) if metadata/data has not yet expired from the secondary storage. The length of time metadata and data stays in the secondary storage is configurable by the user. In such a read-only image of the past file system state metadata all files are virtual. If the user attempts to access a file he will initiate a restore process of such appropriate file data from the secondary storage.

Secure Undelete is a feature that is desirable in most of today's File Systems. It is very difficult to implement in a regular file system. Due to the structure of the SSA system, IFS can easily implement Secure Undelete because the system already contains, at minimum, two copies of a file at any given time. When a user deletes a file, its duplicate can still be stored on the secondary media and will only be deleted after a predefined and configurable period of time or by explicit user request. A record of this file can still be stored in the DBS, so that the file can be securely recovered during this period of time.

A common situation that occurs in today's File Systems is a remarkably slow directory search process (It usually takes several minutes to search a directory with more than a thousand entries in it). This is explained by the method most file systems employ to place data in the directories: linear list of directory entries. IFS, on the other hand, uses a b-tree structure, based on an alphanumeric ordering of entry names, for the placement of entries, which can speed up directory searches significantly.

Generally, each time data needs to be updated in a file system, the metadata (inodes, directories, and superblock) have to be updated as well. The update operation of the latter happens very frequently and usually takes about as much time as it takes to update the data itself, adding at least one extra seek operation on the underlying hard-drive. IFS can offer a novel feature, as compared to existing file systems: the placement of file metadata and data on separate devices. This solves a serious timing problem by placing metadata on a separate, fast device (for example, a solid state disk).

This feature also permits the distributed placement of the file system on several partitions. The metadata of each partition and the generic information (in the form of one generic superblock) about all IFS partitions can be stored on the one fast device. Using this scheme, when a new device is added to the system, its metadata is placed on the separate media and the superblock of that media is updated. If the device is removed, the metadata are removed and the system updates the generic superblock and otherwise cleans up. For the sake of robustness, a copy of the metadata that belongs to a certain partition is made in that partition. This copy is updated each time the IFS is unmounted and also at some regular, configurable intervals.

Each 64-bit data pointer in IFS consists of the device address portion and a block address portion. In one embodiment of the present invention upper 16 bits of the block pointer is used for the device identification and the remaining 48 bits are used to address the block within the device. Such data block pointers allow to store any block on any of the devices under IFS control. It is also obvious that a file in IFS may cross the device boundaries.

The ability to place a file system on several devices makes the size of that file system independent of the size of any particular device. This mechanism also allows for additional system reliability without paying the large cost and footprint penalty associated with standard reliability enhancers (like RAID disk arrays). It also eliminates the need for standard tools used to merge multiple physical disks into a single logical one (like LVM). Most of the important data (primarily metadata) and newly created data can be mirrored to independent devices (possibly attached to different busses to protect against bus failure) automatically by the file system code itself. This eliminates the need for additional hardware devices (like RAID controllers) that can be very costly or additional complex software layers (software RAID) which are generally slow, I/O and computationally expensive (due to parity calculations). Once the newly created data gets copied to the secondary media by the SSA system, the space used by the redundant copy (mirror) can be de-allocated and reused. Thus, to obtain this extra measure of reliability, only a small percentage of the storage space will need be mirrored on expensive media any given time providing higher degree of reliability then that provided by parity RAID configurations and without the overhead of calculating parity. This percentage will depend on the capability of the secondary storage to absorb data and can be kept reasonably small by providing sufficient number of independent secondary storage devices (for example tape or optical drives).

System Calls such as creat( ), open( ), read( ), write( ), and unlink( ) have special implementations in IFS and are described below.

creat( )

As soon as a new file is created, IFS communicates through the Communication Module with the DBS, which creates a new database entry corresponding to the new file.

open( )

When a user opens a file, IFS first checks whether the file's data are already on the primary media (i.e., hard disk). In this case, the IFS proceeds as a “regular” file system and opens the file. If the file is not on the hard drive, however, IFS communicates with the DBS to determine which SMSD contain the file copies. IFS then allocates space for the file. In the event that the Communications Module is not connected to that SSU, IFS connects to it. A request is then made for file to be restored from secondary storage into the allocated space. The appropriate SSU then restores the data, keeping IFS updated as to its progress (this way, even during the transfer, IFS can provide restored data to the user via read( )). All these operations are transparent for the user, who simply “opens” a file. Certainly, opening a file stored on a SMSD will take more time than opening a file already on the primary disk.

read( )

When a large file that resides on a SMSD is being opened, it is very inefficient to transfer all the data to the primary media at once, thus making the user wait for this process to finish before getting any data. IFS maintains an extra variable in the inode (both on disk and in memory) indicating how much of the file's data is on the primary media and thus valid. This allows read( ) to return data to the user as soon as it is restored from secondary media. To make read( ) more efficient, read ahead can be done.

write( ), close( )

The System Administrator defines how many copies of a file should be in the system at a time as well as the time interval at which these copies are updated. When a new file is closed, IFS communicates with the DBS and gets the number of the appropriate SMSD. It is then connected to the SMSD and requests that a copy of the file is made. The SSU then makes copies directly from the disks to secondary storage, alleviating IFS and network transfer overhead. When both primary disks and secondary storage are placed on the same FibreChannel network data transfers can be further simplified and optimized by using FC direct transfer commands.

IFS also maintains a memory structure that reflects the status of all of the files that have been opened for writing. It can keep track of the time when the open( ) call occurred and the time of the last write( ). A separate IFS thread watches this structure for files that stay open longer then a pre-defined time period (on the order of 5 min-4 hours). This thread creates a snapshot of those files if they have been modified and signals the appropriate SSU's to make copies of the snapshot. Thus in the event of a system crash, work in progress stands a good chance of being recoverable.

unlink( )

When a user deletes (unlink( )s) a file, that file is not immediately removed from the SMSD. The only action that is initially taken besides usual removal of file and metadata structures from primary storage is that the file's DBS record is updated to reflect deletion time. The System Administrator can predefine the length of time the file should be kept in the system after having been deleted by a user. After that time is expired, all the copies are removed and the entry in the DBS is cleared. For security reasons this mechanism can be overridden by the user to permanently delete the file immediately if needed. A special ioctl call is used for this.

The Communication Module (CM) serves as a bridge between IFS and all other modules of the Storage System. It is implemented as multi-threaded server. When the IFS needs to communicate with the DBS or a SSU, it is assigned a CM thread which performs the communication.

The MySQL data base server is used for implementation of the DBS, although other servers like Postgres or Sybase Adaptive Server can be used as well. The DBS contains all of the information about files in IFS, secondary storage media, data locations on the secondary storage, historic and current metadata. This information includes the name of a file, the inode, times of creation, deletion and last modification, the id of the device where the file is stored and the state of the file (e.g., whether it is updated or not). The database key for each file is its inode number and device id mapped to a unique identifier. The name of a file is only used by the secure undelete operation (if the user needs to recover the deleted file, IFS sends a request which contains the name of that file and the DBS then searches for it by name). The DBS also contains information about the SMSD devices, their properties and current states of operation. In addition, all SSA modules store their configuration values in the DBS.

The VS is implemented as a daemon process that periodically obtains information about state of the IFS hard disks. When a prescribed size threshold is reached, the VS connects to the DBS and gets a list of files whose data can be removed from the primary media. These files can be chosen on the basis of the time of their last update and their size (older, lager files can be removed first). Once it has the list of files to be removed, the VS gives it to the IFS Communication Module. The Communication Module takes care of passing the information to both IFS and DBS.

The Repack Server (RS) is implemented as a daemon process. It monitors the load on each SMSD. The RS periodically connects to the DBS and obtains the list of devices that need to be repacked (i.e., tapes where the ratio of data to empty space is small and no data can be appended to them any longer). When necessary and allowed by the lower levels, the RS connects to an appropriate SSU and asks it to rewrite its (sparse) data contents to new tapes.

Each Secondary Media Storage Device (SMSD) is logically paired with its own SSU software. This SSU is implemented as a multi threaded server. When a new SMSD is connected to the SSA system, a new SSU server is started which then spawns a thread to connect to the DBS. The information regarding the SSU's parameters is sent to the DBS and the SMSD is registered. This communication between the SSU and the DBS stays in place until the SMSD is disconnected or fails. It is used by the DBS to signal files that should be removed from the SMSD. It is also used to keep track of the SMSD's state variables, such as its load status.

When the IFS needs to write (or read) a file to (or from) a SMSD, it is connected to the appropriate SSU, if not already connected, which spawns a thread to communicate with the IFS. This connection can be performed via a regular network or via a shared memory interface if both IFS and SSU are running on the same controller. The number of simultaneous reads/writes that can be accomplished corresponds to the number of drives in the SMSD. The SSU always gives priority to read requests.

The RS also needs to communicate with the SSU from time to time when it is determined that devices need to be repacked (e.g., rewrite files from highly fragmented tapes to new tapes). When the RS connects to the SSU, the SSU spawns the new thread to serve the request. Requests from the RS have the lowest priority and are served only when the SMSD is in idle state or has a (configurably) sufficient number of idle drives.

The user data access interfaces are divided into the following access methods and corresponding software components:
Network File System (NFS) server handling NFS v. 2, 3 and possibly 4, or WebNFS;
Common Internet File System (CIFS) server;
File Transfer Protocol (FTP) server; and
HyperText Transfer Protocol/HTTP Secure (HTTP/HTTPS) server.

A heavily optimized and modified version of knfsd can be used. In accordance with this software's GNU public license, these modifications can be made available to the Linux community. This is done to avoid the lengthy development and debugging process of this very important and complex piece of software.

Currently knfsd only handles NFS v.2 and 3. Some optimization work can be done on this code. The present invention can also use Sun Microsystems' NFS validation tools to bring this software to full compliance with NFS specifications. As soon as NFS v.4 specifications are released, the present invent can incorporate this protocol into knfsd as well.

Access for Microsoft Windows (9x, 2000, and NT) clients can be provided by a Samba component. Samba is a very reliable, highly optimized, actively supported/developed, and free software product. Several storage vendors already use Samba for providing CIFS access.

The present invention can configure Samba to exclude its domain controller and print sharing features. The present invention can also run extensive tests to ensure maximum compliance with CIFS protocols. FTP access can be provided with a third party ftp daemon. Current choices are NcFTPd and WU-FTPd.

There is a preliminary agreement with C2Net, makers of the Stronghold secure http server to use their product as the http/https server of this invention for the data server and the configurations/reports interface.

User demands may prompt the present invention to incorporate other access protocols (such as Macintosh proprietary file sharing protocols). This should not present any problems since IFS can act as a regular, locally mounted file system on the controller serving data to users.

The management and configuration are divided into the following three access methods and corresponding software components:
Configuration tools;
Reporting tools; and
Configuration access interfaces.

Configuration tools can be implemented as a set of per scripts that can be executed in two different ways: interactively from a command line or via a perlmod in the http server. The second form of execution can output html-formatted pages to be used by a manager's web browser.

Most configuration scripts will modify DBS records for the respective components. Configuration tools should be able to modify at least the following parameters (by respective component):
OS configuration: IP address, netmask, default gateway, Doman Name Service (DNS)/Network Information System (NIS) server for each external (client-visible) interface. The same tool can allow bringing different interfaces up or down. Simple Network Management Protocol (SNMP) configuration.

IFS Configuration: adding and removing disks, forcing disks to be cleared (data moved elsewhere), setting number of HSM copies globally or for individual files/directories, marking files as non-virtual (disk-persistent), time to store deleted files, snapshot schedule, creating historic images, etc.

Migration Server: specifying min/max disk free space, frequency of the migrations, etc.

SSU's: adding or removing SSU's, configuring robots, checking media inventory, exporting media sets for off-site storage or vaulting, adding media, changing status of the media, etc.

Repack Server: frequency of repack, priority of repack, triggering data/empty space ratio, etc.
Access Control: NFS, CIFS, FTP, and HTTP/HTTPS client and access control lists (separate for all protocols or global), disabling unneeded access methods for security or other reasons.

Failover Configuration: forcing failover for maintenance/upgrades.

Notification Configuration: configuring syslog filters, e-mail destination for critical events and statistics.

Reporting tools can be made in a similar fashion as configuration tools to be used both as command-line and HTTPS-based. Some statistical information can be available via SNMP. Certain events can also be reported via SNMP traps (e.g., device failures, critical condition, etc.). Several types of statistical, status, and configuration information types can be made available through reporting interfaces:
Uptime, capacity, and used space per hierarchy level and globally, access statistics including pattern graphs per access protocol, client IP's, etc.
Hardware status view: working status, load on a per-device level, etc.
Secondary media inventory on per-SSU level, data and cleaning media requests, etc.
OS statistics: loads, network interface statistics, errors/collisions statistics and such.
E-mail for active statistics, event and request reporting.

The present invention can provide the following five basic configuration and reporting interfaces:
HTTPS: using C2Net Stronghold product with our scripts as described in 3.6.1 and 3.6.2.
Command-line via a limited shell accessible either through a serial console or via ssh (telnet optional, disabled by default).
SNMP for passive statistics reporting.
SNMP traps for active event reporting.
E-mail for active statistics, event and request reporting.

The system log can play important role in SSA product. Both controllers can run their own copy of our modified syslog daemon. They can each log all of their messages locally to a file and remotely to the other controller. They can also pipe messages to a filter capable of e-mailing certain events to the technical support team and/or the customer's local systems administrator.

The present invention can use the existing freeware syslog daemon as a base. It can be enhanced with the following features:
The ability to not forward external (originating from the network) messages to external syslog facilities. This feature is necessary to avoid logging loops between two controllers.
The ability to only bind to specific network interfaces for listening to remote messages. This feature will prevent some denial of service attacks from outside the SSA product. The present invention can configure the syslog to only listen to the messages originating on a private network between two controllers.
The ability to log messages to pipes and message queues. This is necessary to be able to get messages to external filters that take actions on certain triggering events (actions like e-mail to sysadmin and/or tech. support).
The ability to detect a failed logging destination and cease logging to it. This is necessary to avoid losing all logging abilities in case of the failure of remote log reception or of a local pipe/queue.

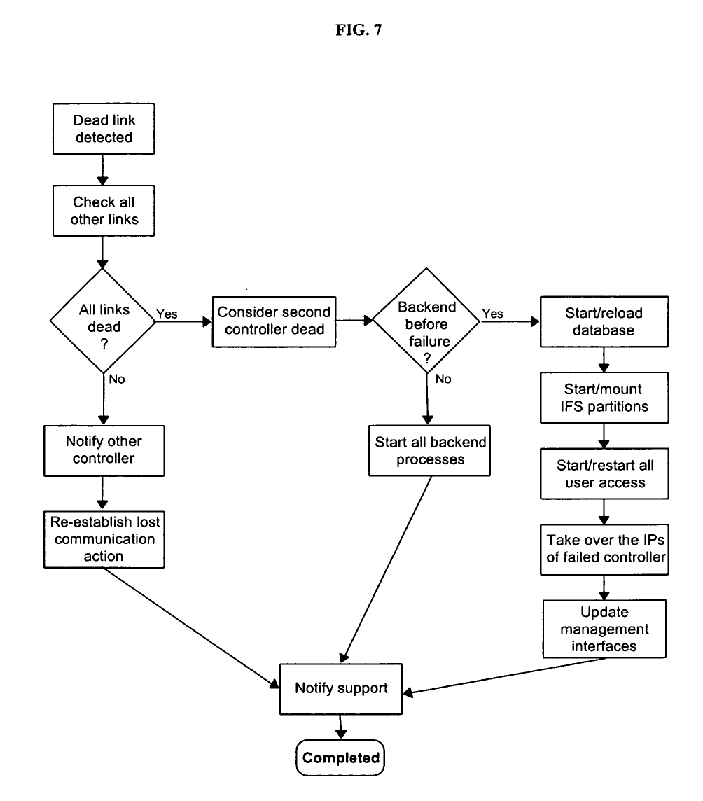

Both controllers can monitor each other with a heartbeat package over the private network and several FibreChannel loops. This allows the detection of controller failure and private network/Fc network failures. In case of total controller failure, the surviving controller notifies the Data Foundation support team and takes over the functions of the failed controller. The sequence of events is shown in FIG. 7.

The present invention has been described in terms of preferred embodiments, however, it will be appreciated that various modifications and improvements may be made to the described embodiments without departing from the scope of the invention.

1. A method for storing data in a storage system comprising:
applying a location algorithm to a unit of data to select a storage location suitable for the data unit;
applying an allocation algorithm to the selected storage location and the data unit to assign the data unit a physical location within the selected storage location;
storing the data unit in the assigned physical location within the selected storage location;
creating meta data relating to the data unit and the assigned physical location within the selected storage unit; and
storing the meta data at a location other than the selected storage location.
